(19) United States
(12) Patent Application Publication
(10) Pub. No.: US 2023/0133104 A1
(43) Pub. Date: May 4, 2023

(54) Magnetic organizer system

(71) Applicant: Chase Massingill, Gatesville, TX (US)

(72) Inventor: Chase Massingill, Gatesville, TX (US)

(21) Appl. No.: 18/049,947

(22) Filed: Oct. 26, 2022

Related U.S. Application Data
(60) Provisional application No. 63/274,875, filed on Nov. 2, 2021.

(51) Int. Cl. B65D 71/62; A45F 5/10; F16M 13/02

(52) U.S. Cl. CPC B65D 71/004; A45F 5/10; F16M 13/02; A45F 2200/0508; A45F 2200/0525; A45F 2200/0516; A45F 2200/0583

(57) ABSTRACT

The present invention is a magnetic organizer system comprised of a plurality of compartments or pockets that are designed to hold a person's items such as tablets, notebooks, phones, beverages, and writing utensils. The present invention further comprises a magnet which allows the present invention to be attached to magnetic surfaces such as gym equipment, automobiles, refrigerators, and metal walls or roofs. The present invention is further comprised of a towel ring for hang towels, rags, or garments. The magnetic organizer system is further of side rings which allow for the clipping of attachment of other items including keychains, hooks, clips, or carabiners.

### FIELD OF THE INVENTION

The present invention relates generally to organizers. More specifically, the present invention relates to a magnetic utility or workout organizer system.

### BACKGROUND OF THE INVENTION

During normal routines and activities, people carry around a number of items such as tablets, phones, drinks, and writing utensils that they may use during the course of those activities. Some of these items do not fit into a pocket and some routines such as weightlifting, do not allow a person to have these items in their pockets. Most of the time, during these routines and activities there is no designated place for a person to set their items, therefore most time these items end up on the floor or in random locations.

Further these activities may require the person to continually move or change locations. With each move, the person is required to collect all of their items, move to the next location and set them back down. Many of these personal items are delicate or valuable, so setting these items on the floor or other random locations is not ideal.

Therefore, there is a need for a system that holds and organizes a person's items during normal routines and activities.

### SUMMARY OF THE INVENTION

The present invention is an organizer system, having a number of compartments or pockets to store, organize, and carry a person's items. The compartments or pockets of the present invention have varying sizes that allow a person to store a wide variety of items such as notebooks, tablets, phones, beverages, and writing utensils. With these items stored in their respective compartment, a person may easily access each item. This organization and easy access helps a person to quickly and easily perform tasks such as writing down notes, taking a phone call, or getting a drink.

The organizer system is further comprised of a magnet which enables it to magnetically attach to surfaces such as gym equipment, refrigerators, cars, or metal walls or roofs. Further, the present invention is designed to stand up straight on any flat surface.

Further, the organizer system is able to safely store and carry delicate or expensive items. The ability to store and carry all of their items within the present invention allows a person to easily and safely store and move their items during their normal routines and activities, such as weightlifting, working out, construction, automotive repair, tailgating, or at the beach.

### BRIEF DESCRIPTION OF THE DRAWINGS

FIG. 1 shows a top left prospective view of a preferred embodiment of the present invention.

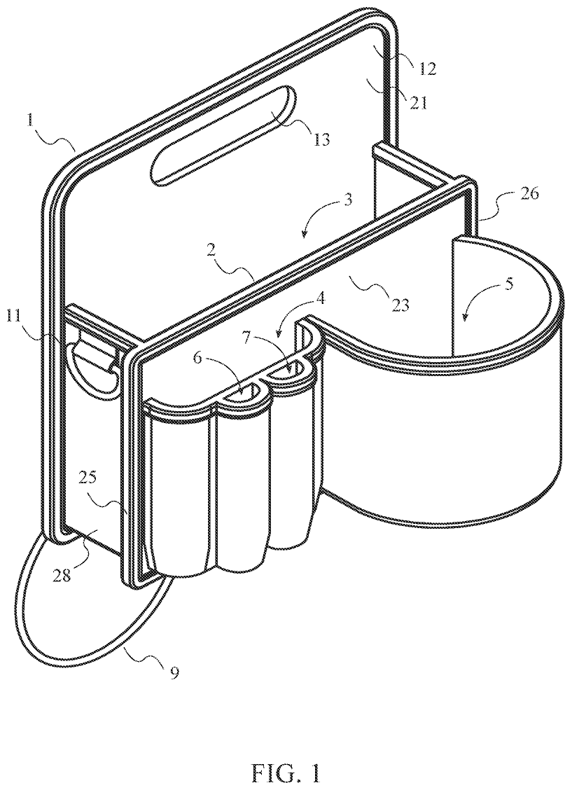

FIG. 2 shows a rear left prospective view of a preferred embodiment of the present invention.

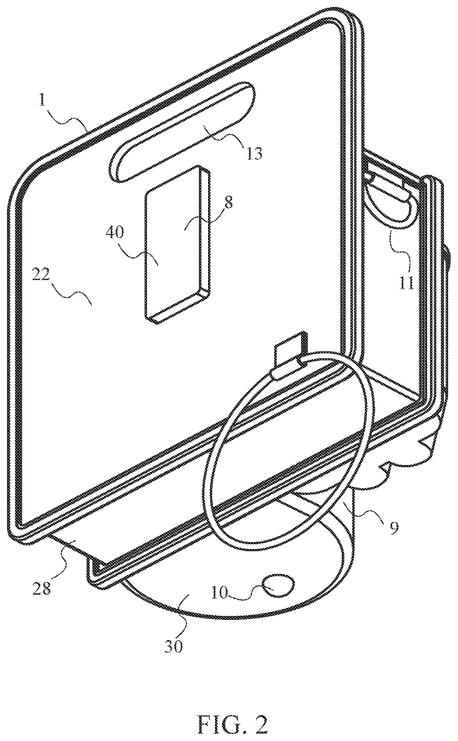

FIG. 3 shows a rear elevation view of a preferred embodiment of the present invention.

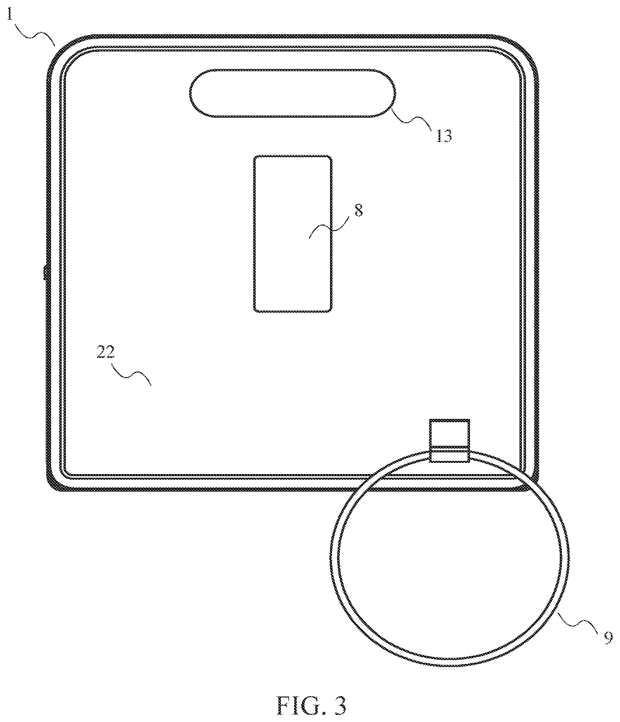

FIG. 4 shows a front elevation view of a preferred embodiment of the present invention.

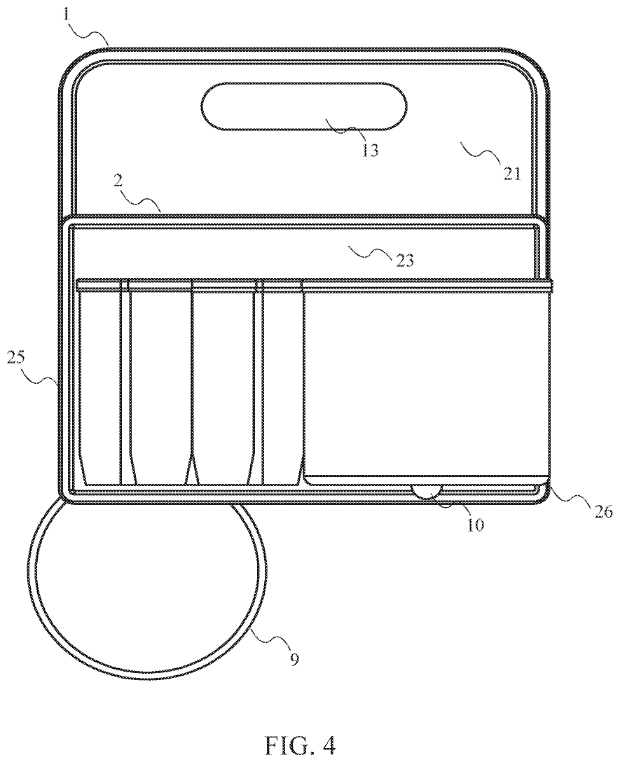

FIG. 5 shows a left elevation view of a preferred embodiment of the present invention.

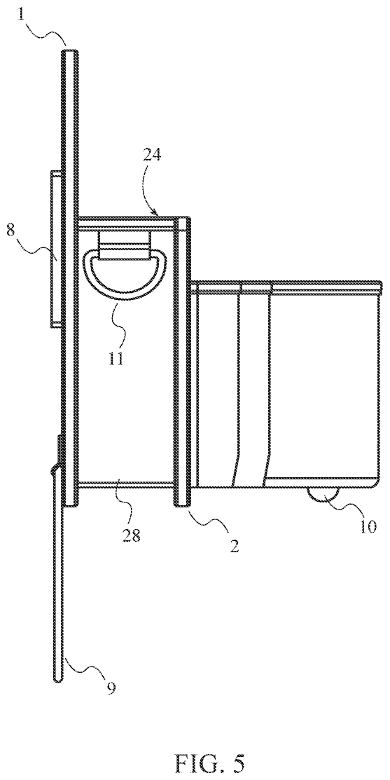

FIG. 6 shows a top plan view of a preferred embodiment of the present invention.

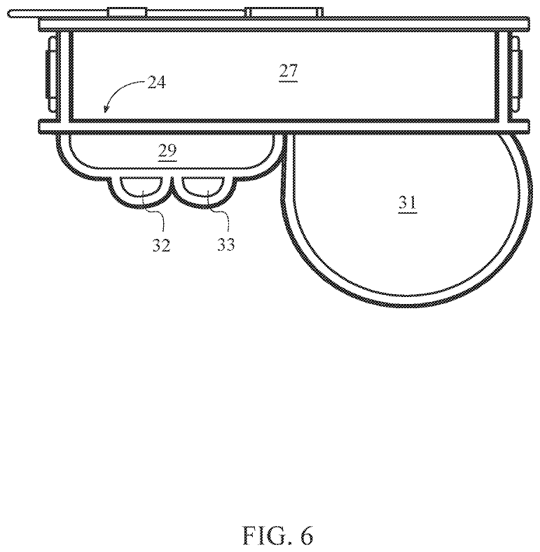

FIG. 7 shows top left prospective view of a reduced size embodiment of the present invention.

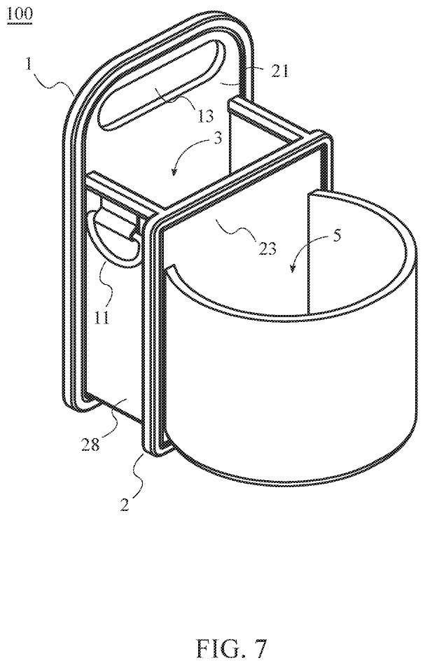

FIG. 8 shows a rear left prospective view of a reduced size embodiment of the present invention.

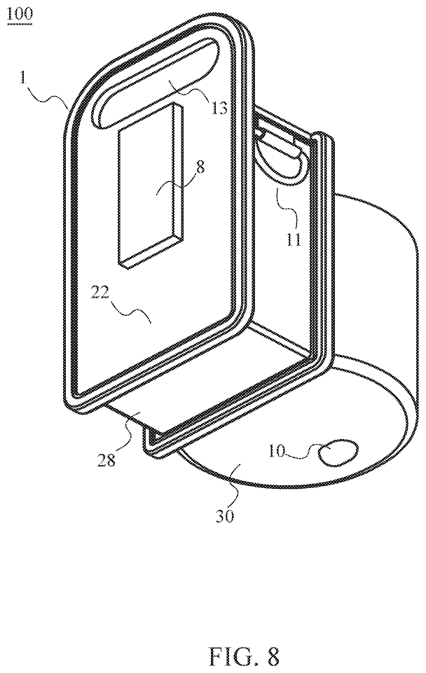

FIG. 9 shows a front elevation view of a reduced size embodiment of the present invention.

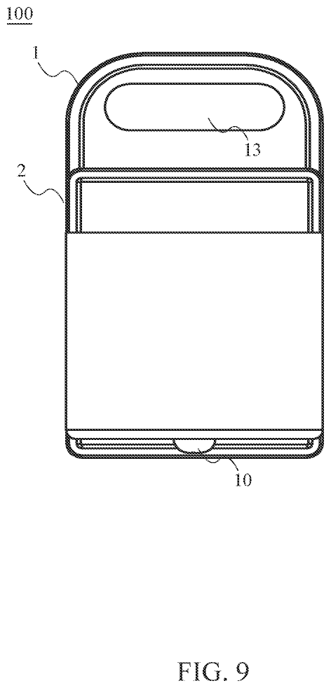

FIG. 10 shows a rear elevation view of a reduced size embodiment of the present invention.

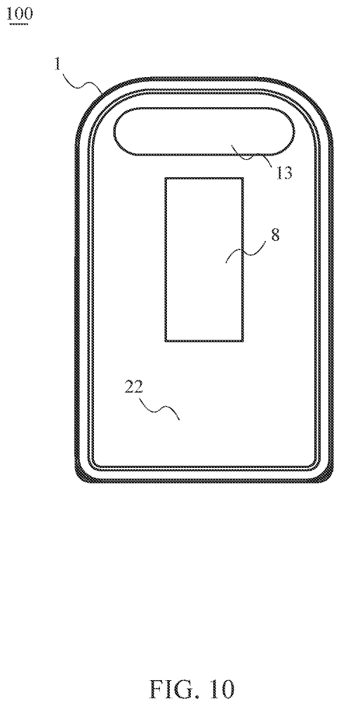

### DETAIL DESCRIPTIONS OF THE INVENTION

All illustrations of the drawings are for the purpose of describing selected versions of the present invention and are not intended to limit the scope of the present invention.

The present invention is a magnetic organizer system which is utilized to organize, contain, and carry a person's items. The present invention comprising of a back wall 1, a front wall 2, a large compartment 3, a medium compartment 4, and a beverage compartment 5.

The back wall 1 of the present invention serves as a main structural member, adding rigidity and strength. This rigidity and strength allow the back wall 1 to support the weight of magnetic organizer system without significant bending or deflection. The back wall 1 has an exterior surface 22 which forms the exterior rear face of the present invention, with an interior surface 21 opposite to the exterior surface 22.

In a preferred embodiment of the present invention, the back wall 1 is comprised of strong fabric layers with a rigid panel 12, the rigid panel 12 consisting of any suitable type of rigid material such as plastic, or various types of stiff boards. In the preferred embodiment, the rigid panel 12 is sewn in between two layers of the fabric. Further embodiments of the back wall 1 may utilize different means of adding stiffness and rigidity.

In a preferred embodiment of the present invention, the back wall 1 is further comprised of a handle 13. The handle 13 being configured to allow a person to pick and carry the magnetic organizer system. In this preferred embodiment, the handle 13 is cut out of the back wall 1. The cutout section being sized relatively similar to the size of a person's hand. The cut out being padded and lined to increase the comfort when in use. In further embodiments the handle 13 can take other forms. As an exemplary further embodiment the handle 13 can be created from webbing material and attached to the back wall 1.

The front wall 2 of the present invention is constructed similar to the back wall 1. The front wall 2 has similar dimensions to the back wall 1 expect, the front wall 2 is shorter in height relative to the back wall 1. The main function of the front wall 2 is to provide structure in between the compartments of the present invention. The front wall 2 has a rear surface 24 which faces the back wall 1 and a front surface 23 opposite of the rear surface 24. Further, the front wall 2 has a first end 25 and a second end 26.

The large compartment 3 of the present invention is a compartment or pocket that is formed in between the interior surface 21 of the back wall 1 and the rear surface 24 of the front wall 2. The large compartment 3 is sized similarly to the size of a notebook or a computer tablet. The large compartment 3 having a top opening 27 which is open to allow for the access and remove of items. Further, the sides and bottom of the large compartment 3 are formed by a sidewall 28 that runs around the perimeter of the large compartment 3. The sidewall 28 is terminally connected to the back wall 1 and the front wall 2.

The medium compartment 4 of the present invention is a compartment or pocket that extends outward from the front surface 23 of the front wall 2, adjacent to the first end 25 of the front wall 2. The medium compartment 4 having an upper opening 29 which is open to allow for the access and remove of items. The medium compartment 4 is sized similarly to the size of a phone or a pocket-sized object. In a preferred embodiment the medium compartment 4 is gusseted to allow for thicker objects such as phones with large cases or phones with grips and mounts.

The beverage compartment 5 of the present invention is a compartment or pocket that extends outward from the front surface 23 of the front wall 2, adjacent to the second end 26 of the front wall 2, opposite of the medium compartment 4. The beverage compartment 5 having a beverage opening 31 on its top surface which is open to allow for the access and remove of items. The beverage compartment 5 is sized similarly to beverage containers, some examples of beverage containers being shaker cups, insulated mugs, and water bottles.

The present invention is further comprised of a first utensil compartment 6 and a second utensil compartment 7. In a preferred embodiment both the first utensil compartment 6 and the second utensil compartment 7 extend outward from the medium compartment 4. The first utensil compartment 6 having a first utensil opening 32 which is open to allow for the access and remove of items. The second utensil compartment 7 having a second utensil opening 33 which is open to allow for the access and remove of items.

In a preferred embodiment, both the first utensil compartment 6 and the second utensil compartment 7 are sized having a longer height relative to their width. The tall height of the first utensil compartment 6 and the second utensil compartment 7 are sized similarly to elongated objects or utensils such as a screwdriver, pencil, or other writing utensil.

The present invention is further comprised of a magnet 8. The magnet 8 being any device having a magnetic attraction that is capable of magnetically attaching to a surface. The magnet 8 is used to attach and hold the weight of the present invention and its contents to surfaces that can be magnetically attached to such as refrigerators, gym equipment, cars, or metal wall or roofs. In the preferred embodiment, the magnet 8 is affixed to the exterior surface 22 of the back wall 1. Further, in the preferred embodiment, the magnet 8 is further comprised of a rubber coating 40 or coated with another substance which ensures the magnet 8 does not scratch or damage the surface the present invention is attached to. The magnet 8 maybe attached to the present invention through any suitable means such as adhesive or fasteners.

The present invention is further comprised of a towel ring 9. The towel ring 9 being a ring or band of material, having a diameter wide enough to allow a towel, rag, or garment to be threaded through. The towel ring 9 allows a person to thread and drape a towel, cleaning rag, or garment through its diameter. Further, items may be clipped, attached, or hooked to the towel ring 9, such as carabiners, clips, earbuds, or keychains. In a preferred embodiment, the towel ring 9 is attached by a loop of webbing to the exterior surface 22 of the back wall 1. Further, in the preferred embodiment, the towel is located adjacent to the magnet 8, so that the towel ring 9 may be magnetically attached and held by the magnet 8 when not in use.

The present invention is further comprised of a leg 10. The leg 10 is located on the bottom surface 30 of the beverage compartment 5. In a preferred embodiment, the leg 10 is created from a metallic half sphere. Due to the design of the magnetic organizer system, when the back wall 1 and front wall 2 of the organizer are set down on a flat surface, the bottom surface 30 of the beverage compartment 5 is still in the air above the surface. Therefore, if the magnetic organizer system is placed on a flat surface with items in the medium compartment 4 or in the beverage compartment 5, there is a tendency for the magnetic organizer system to tilt or lean forward. In some cases, this tilt or lean could lead to the magnetic organizer system tipping over. By add the leg 10 to the bottom surface 30 of the beverage compartment 5, the beverage compartment 5 is now supported when the magnetic organizer system is set on a flat surface. Thereby, eliminating the tendency to tip or spill.

The present invention is further comprised of a set of side rings 11. These side rings 11 are configured to allow a person to clip, hook, or attach items to the side rings 11. Some exemplary examples of items that can be attached to these side rings 11 include keyrings, carabiners, earbuds, and other clips. In a preferred embodiment of the present invention, a set of side rings 11 are affixed with a loop of webbing to the sidewall 28 of the large compartment 3. With one side ring on each side of the large compartment 3 facing outward, opposite the large compartment 3.

In a preferred embodiment of the present invention the compartments of the present invention would be created from a strong fabric such as a nylon or canvas. These strong fabrics would create the wall and divides of the compartments in the present invention. In further embodiments other fabrics may be utilized without changing the scope or spirit of the invention.

Further embodiments of the present invention may contain a reduced or increased number of compartments or pockets. In a reduced size embodiment 100, the present invention is comprised of a back wall 1, a front wall 2, a large compartment 3, and a beverage compartment 5.

The reduced size embodiment 100 being further comprised of a magnet 8, a leg 10, a handle 13, and a set of side rings 11.

Although the invention has been explained in relation to its preferred embodiment, it is to be understood that many other possible modifications and variations can be made without departing from the spirit and scope of the invention.

What is claimed is:

1. A magnetic organizer system comprises:
a back wall;
a front wall;
a large compartment;
a medium compartment;
a beverage compartment;
the back wall having an interior surface and an exterior surface;
the front wall having a front surface and a rear surface;
the large compartment extending between the interior surface of the back wall to the rear surface of the front wall;
the medium compartment and the beverage compartment extending outward from the front surface of the front wall;
the medium compartment being adjacent to a first end of the front wall; and
the beverage compartment being adjacent to a second end of the front wall.

2. The magnetic organizer system as claimed in claim 1 comprises:
a magnet; and
the magnet being affixed to the exterior surface of the back wall.

3. The magnetic organizer system as claimed in claim 2 comprises:
the magnet further comprises a rubber coating.

4. The magnetic organizer system as claimed in claim 2 comprises:
a first utensil compartment;
a second utensil compartment; and
the first utensil compartment and second utensil compartment extend outward from the medium compartment.

5. The magnetic organizer system as claimed in claim 2 comprises:
a towel ring; and
the towel ring being attached to the exterior surface of the back wall.

6. The magnetic organizer system as claimed in claim 2 comprises:
a leg;
the leg being affixed to a bottom surface of the beverage compartment;

7. The magnetic organizer system as claimed in claim 2 comprises:
the back wall further comprises a rigid panel.

8. The magnetic organizer system as claimed in claim 2 comprises:
the back wall further comprises a handle.

9. The magnetic organizer system as claimed in claim 2 comprises:
a set of side rings; and
the set of side rings being attached to the exterior of the large compartment.

10. A magnetic organizer system comprises:
a back wall;
a front wall;
a large compartment;
a beverage compartment;
the back wall having an interior surface and an exterior surface;
the front wall having a front surface and a rear surface;
the large compartment extending between the interior surface of the back wall to the rear surface of the front wall; and
the beverage compartment extending outward from the front surface of the front wall.

11. The magnetic organizer system as claimed in claim 10 comprises:
a magnet; and
the magnet being affixed to the exterior surface of the back wall.

12. The magnetic organizer system as claimed in claim 11 comprises:
the magnet further comprises a rubber coating.

13. The magnetic organizer system as claimed in claim 11 comprises:
a leg;
the leg being affixed to a bottom surface of the beverage compartment;

14. The magnetic organizer system as claimed in claim 11 comprises:
the back wall further comprises a rigid panel.

15. The magnetic organizer system as claimed in claim 11 comprises:
the back wall further comprises a handle.

16. The magnetic organizer system as claimed in claim 11 comprises:
a set of side rings; and
the set of side rings being attached to the exterior of the large compartment.

17. A magnetic organizer system comprises:
a back wall;
a front wall;
a large compartment;
a medium compartment;
a beverage compartment;
a magnet;
a first utensil compartment;
a second utensil compartment;
a leg;
a set of side rings;
the back wall having an interior surface and an exterior surface;
the front wall having a front surface and a rear surface;
the large compartment extending between the interior surface of the back wall to the rear surface of the front wall;
the medium compartment and the beverage compartment extending outward from the front surface of the front wall;
the medium compartment being adjacent to a first end of the front wall; and
the beverage compartment being adjacent to a second end of the front wall.
the magnet being affixed to the exterior surface of the back wall.
the first utensil compartment and second utensil compartment extend outward from the medium compartment.
the back wall further comprises a rigid panel.
the leg being affixed to a bottom surface of the beverage compartment;
the set of side rings being attached to the exterior of the large compartment.

18. The magnetic organizer system as claimed in claim 2 comprises:
the magnet further comprises a rubber coating.

19. The magnetic organizer system as claimed in claim 2 comprises:
a towel ring; and
the towel ring being attached to the exterior surface of the back wall.

20. The magnetic organizer system as claimed in claim 2 comprises:
the back wall further comprises a handle.
